(19) United States
(12) Patent Application Publication
(10) Pub. No.: US 2026/0091599 A1
(43) Pub. Date: Apr. 2, 2026

(54) MEDIUM DISCHARGE DEVICE, MEDIUM PROCESSING DEVICE, AND METHOD FOR CONTROLLING MEDIUM DISCHARGE DEVICE

(71) Applicant: SEIKO EPSON CORPORATION, Tokyo (JP)

(72) Inventors: Riku MAEDA, SHIOJIRI-SHI (JP); Hiroyuki KOSUGE, MATSUMOTO-SHI (JP); Kazuyoshi OHASHI, MATSUMOTO-SHI (JP)

(21) Appl. No.: 19/343,011

(22) Filed: Sep. 29, 2025

(30) Foreign Application Priority Data
Oct. 1, 2024 (JP) 2024-172046

(51) Int. Cl. B41J 13/10; B41J 13/00; B41J 29/00

(52) U.S. Cl. CPC B41J 13/106; B41J 13/0036; B41J 29/00

(57) ABSTRACT

The medium discharge device 50 includes a mount section 6a, on which a medium tray 61a for stackable medium P is detachably mounted; a discharge port 5a that discharges the medium P onto the medium tray 61a mounted on the mount section 6a; a detection section that detects a “removal operation of the stacking section” for removing the medium tray 61a from the mount section 6a; a restriction section 7a capable of “restriction of removal of the stacking section” that restricts removal of the medium tray 61a from the mount section 6a; and control sections 90 and 91, wherein When the detection section detects the “removal operation of the stacking section,” the control sections 90 and 91 releases the “restriction of removal of the stacking section” by the restriction section 7a after discharge of the medium P from the discharge port 5a is stopped.

The present application is based on, and claims priority from JP Application Serial Number 2024-172046, filed Oct. 1, 2024, the disclosure of which is hereby incorporated by reference herein in its entirety.

### BACKGROUND

### 1. Technical Field

The present disclosure relates to a medium discharge device, a medium processing device, and a method for controlling a medium discharge device.

### 2. Related Art

In JP-A-2009-120320, an image forming device is disclosed as an image forming device including a sheet discharge tray on which a paper sheet is placed, a discharge section that discharges the paper sheet onto the sheet discharge tray, a distance measuring section, and a control section. The distance measuring section measures a distance, in a direction that is parallel to the bottom surface of the sheet discharge tray and that is orthogonal to a paper sheet discharge direction of the discharge section, to an object on the sheet discharge tray that is located at a position separated from the bottom surface of the sheet discharge tray by a predetermined distance in a paper sheet stacking direction. The control section stops discharge of the paper sheet by the discharge section when the distance measured by the distance measuring section is less than a specific distance as a criterion for judgement. By this, it prevents the paper sheets already stacked on the sheet discharge tray from colliding with a paper sheet subsequently discharged to the sheet discharge tray.

However, in the image forming device disclosed in JP-A-2009-120320, there is a risk that a user cannot stop discharge of the paper sheet by the discharge section at an arbitrary timing.

### SUMMARY

The medium discharge device includes a mount section to which is detachably mountable a stacking section on which a medium is stackable; a discharge section that discharges the medium to the stacking section mounted on the mount section; a detection section configured to detect a removal operation of the stacking section from the mount section; a restriction section configured to restrict removal of the stacking section from the mount section; and a control section, wherein when the detection section detects the removal operation of the stacking section, then after stopping discharge of the medium from the discharge section, the control section releases restriction of removal of the stacking section by the restriction section.

A medium processing device includes a process section that performs processing on a medium and the medium discharge device that discharges the medium processed by the process section.

A control method for a medium discharge device including a mount section to which a stacking section on which a medium is stacked is detachably mounted, and a discharge section that discharges the medium to the stacking section mounted on the mounting portion, the control method includes: stopping the discharge of the medium from the discharge section when a removal operation of the stacking section for removing the stacking section from the mount section is detected and releasing the restriction of removal of the stacking section from the mount section after the discharge of the medium from the discharge section is stopped.

### BRIEF DESCRIPTION OF THE DRAWINGS

FIG. 1 is a schematic cross-sectional view illustrating a schematic configuration of a medium processing device according to an embodiment.

FIG. 2 is a flowchart illustrating processing when a removal operation of the stacking section is detected.

FIG. 3 is a schematic cross-sectional view illustrating a medium transported in the medium processing device according to the embodiment.

FIG. 4 is a schematic cross-sectional view illustrating a medium transported in the medium processing device according to the embodiment.

FIG. 5 is a schematic cross-sectional view illustrating a medium transported in the medium processing device according to the embodiment.

FIG. 6 is a schematic cross-sectional view illustrating a medium transported in the medium processing device according to the embodiment.

FIG. 7 is a schematic cross-sectional view illustrating a medium transported in the medium processing device according to the embodiment.

FIG. 8 is a schematic cross-sectional view illustrating a medium transported in the medium processing device according to the embodiment.

FIG. 9 is a schematic cross-sectional view illustrating a medium transported in the medium processing device according to the embodiment.

FIG. 10 is a schematic cross-sectional view illustrating a medium transported in the medium processing device according to the embodiment.

FIG. 11 is a schematic cross-sectional view illustrating a medium transported in the medium processing device according to the embodiment.

FIG. 12 is a schematic cross-sectional view illustrating a medium transported in the medium processing device according to the embodiment.

FIG. 13 is a schematic cross-sectional view illustrating a medium transported in the medium processing device according to the embodiment.

### DESCRIPTION OF EMBODIMENTS

Hereinafter, the present disclosure will be described based on embodiments. In the drawings, the same component members are denoted by the same reference numerals, and redundant description may be omitted. As used herein, the terms “same,” “identical,” and “simultaneous” do not necessarily mean exactly the same or occurring at precisely the same time.

For example, in the present specification, the terms “same,” “identical,” and “simultaneously” include cases where values are regarded as equivalent, taking measurement error into account. In the present specification, the terms “same,” “identical,” and “simultaneous” are used to include cases where differences due to manufacturing variations of components are acceptable.

In the present specification, the terms “same,” “identical,” and “simultaneous” are used to include cases where the functions are considered equivalent, provided that the functions are not impaired. Therefore, for example, “both dimensions are the same” means that a dimensional difference between both dimensions is within ±5 % of one of the dimensions, particularly preferably within ±3 %, in consideration of measurement errors and manufacturing variations of the components.

In each drawing, X, Y, and Z represent three spatial axes orthogonal to each other. In the present specification, directions along these axes are referred to as an X-axial direction, a Y-axial direction, and a Z-axial direction. When specifying directions, use “+” for the positive direction and “−” for the negative direction. Indicate direction using these signs, with the direction of the arrow in each diagram representing the positive direction, and the opposite direction of the arrow representing the negative direction.

The Z-axial direction indicates a gravity direction, a +Z-axial direction indicates a vertically upward direction, and a −Z axial direction indicates a vertically downward direction.

A plane including an X-axis and a Y-axis is described as an X-Y plane, a plane including the X-axis and a Z-axis as an X-Z plane, and a plane including the Y-axis and the Z-axis as a Y-Z plane. The X-Y plane is a horizontal plane. Three spatial axes of X, Y, and Z that do not limit the positive direction or the negative direction will be described as an X-axis, a Y-axis, and a Z-axis.

The X-axial direction is a horizontal direction along an installation surface G, which is a horizontal surface on which a medium processing device 1 is installed. The X-axial direction is a depth direction of the medium processing device 1 and is a width direction of the medium P transported in the medium processing device 1. The transport of the medium P includes feeding, transporting, and discharging of the medium P.

In the X-axial direction, the +X direction is a direction from the front surface of the device toward the rear surface of the device, and the −X direction is a direction from the rear surface of the device toward the front surface of the device.

The Y-axial direction is a horizontal direction along an installation surface G on which the medium processing device 1 is installed. The Y-axial direction is the width direction of the medium processing device 1. When the medium processing device 1 is viewed from the front, the +Y direction is the left side, and the −Y direction is the right side. The front surface of the medium processing device 1 is a surface on a side where a reception section 11 operated by a user to give an instruction to the medium processing device 1 is located.

The Z-axial direction is a normal line direction with respect to an installation surface G on which the medium processing device 1 is installed and is a height direction of the medium processing device 1. In the following description, the +Z direction may be referred to as “vertically upward,” and the −Z direction may be referred to as “vertically downward.”

In the following description, in the medium processing device 1, a direction in which the medium P is transported may be referred to as “downstream”, and a direction opposite to the transport direction may be referred to as “upstream”. The transport direction of the medium P includes a feed direction, a transport direction, and a discharge direction of the medium P.

In each drawing, a transport path through which the medium P is transported is indicated by a two-dot chain line. In the medium processing device 1, the medium P is transported through a transport path indicated by a two-dot chain line. For convenience of illustration, the size of each component may be different from the actual size.

A schematic configuration of the medium processing device 1 according to an embodiment will be described. In the present embodiment, the medium processing device 1 is configured as an inkjet printer and forms an image by ejecting ink onto a medium P, which is an example of a single paper sheet such as printing paper sheet. Ink is an example of liquid.

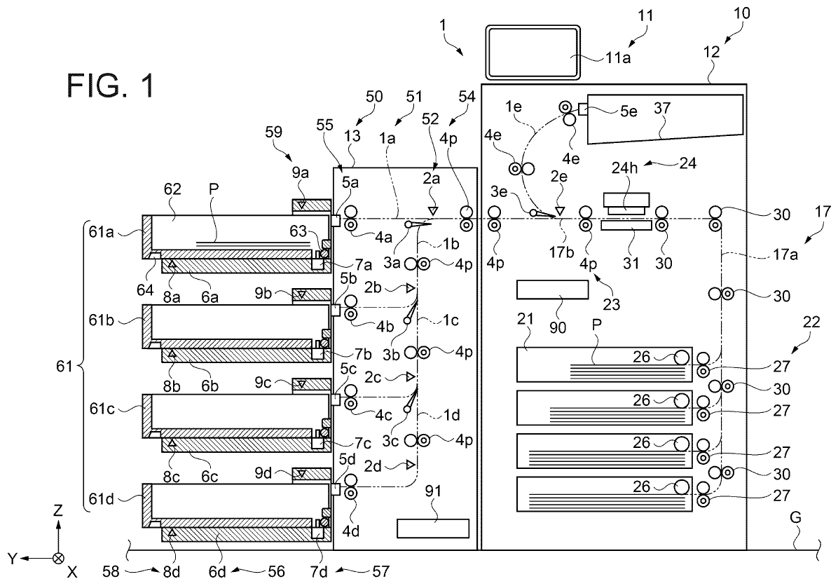

As illustrated in FIG. 1, the medium processing device 1 includes a device main body 10 and a medium discharge device 50. The device main body 10 performs recording by ejecting ink from a recording section 24 provided in the device main body 10 onto the medium P. The medium discharge device 50 discharges the medium P on which recording has been performed by the recording section 24 to a medium tray 61. The medium P is discharged to the medium tray 61 of the present embodiment in a posture in which the surface of the medium P that was just recorded on faces upward.

A housing 13 of the medium discharge device 50 is arranged at a position adjacent to a housing 12 of the device main body 10 on the +Y direction side. By this, the medium processing device 1 includes the medium discharge device 50 at a position on the +Y direction side with respect to the device main body 10. It can be said that the medium processing device 1 includes the medium discharge device 50 downstream of the device main body 10 in the transport direction of the medium P.

The device main body 10 of the medium processing device 1 includes the reception section 11, a transport path 17, a medium accommodation section 21, a transport section 22, a transport section 23, a recording section 24, a medium receiver 37, and a control section 90. The medium discharge device 50 of the medium processing device 1 includes a transport path 51, a transport section 54, a discharge port 55, a mount section 56, and a control section 91.

The transport path 51 includes discharge paths 1a, 1b, 1c, and 1d. The transport section 54 includes transport roller pairs 4p, 4a, 4b, 4c, and 4d. The transport section 54 includes a medium detection section 52. The medium detection section 52 includes medium detection sections 2a, 2b, 2c, and 2d. The discharge port 55 includes discharge ports 5a, 5b, 5c, and 5d. The mount section 56 includes mount sections 6a, 6b, 6c, and 6d.

The medium tray 61 detachably mounted on the mount section 56 may be prepared separately from the medium discharge device 50 or may be included in the medium discharge device 50.

The housing 13 of the medium discharge device 50 may be integrally formed with the housing 12 of the device main body 10.

The discharge paths 17b and 1e (to be described later) of the transport path 17, the transport section 23, a medium detection section 2e, the discharge port 5e, and the medium receiver 37 may be included in the medium discharge device 50.

In this case, the housing 13 of the medium discharge device 50 may be configured separately from the housing 12 of the device main body 10 or may be configured integrally with the housing 12 of the device main body 10.

The reception section 11 is provided on an upper side surface of the device main body 10 on the-X direction side, which is the front side of the housing 12. The reception section 11 includes a display section 11a including a touch panel. The user can input commands to the medium processing device 1 by touching the display section 11a.

For example, when the user records the image data on the medium P, the user can set, through the reception section 11, which of the medium trays 61a, 61b, 61c, and 61d is to be the discharge destination to which the recorded medium P is to be discharged. The reception section 11 may include an operation button.

The transport path 17 is configured by a feeding path 17a, a discharge path 17b, and a discharge path 1e. The feeding path 17a is a transport path for transporting the medium P from the medium accommodation section 21 to a medium support section 31.

The discharge path 17b follows the feeding path 17a downstream. The discharge path 17b is a transport path for transporting the medium P recorded by the recording section 24 downstream. The downstream end of the discharge path 17b is coupled with the discharge path 1a constituting the transport path 51 of the medium discharge device 50.

The discharge path 1e is a transport path that branches off from an intermediate section of the discharge path 17b and is used to discharge the medium P on which recording has been performed by the recording section 24 from the discharge port 5e. The discharge port 5e is an opening provided in the housing 12 so that the medium P transported through the discharge path 1e can be discharged toward the medium receiver 37.

The medium P discharged from the discharge port 5e is stacked on the medium receiver 37. The medium P is discharged to the medium receiver 37 of the present embodiment in a posture in which the surface of the medium P that was just recorded on faces downward.

The medium accommodation section 21 is a cassette-type accommodating section capable of accommodating the medium P in a stacked state. At least one (four in FIG. 1) medium accommodation section 21 is provided in the device main body 10 so as to be attachable to and detachable from the −X direction side of the device main body 10.

The transport section 22 feeds the medium P stored in the medium accommodation section 21 toward the medium support section 31 via the feeding path 17a. The transport section 22 includes a pickup roller 26, a separation roller pair 27, and a transport roller pair 30.

The pickup roller 26 rotates in accordance with driving of a feed motor (not illustrated). By this, the pickup roller 26 feeds the uppermost sheet of medium P of the medium P disposed in a stacked state in the medium accommodation section 21 downstream.

The separation roller pair 27 rotates in accordance with driving of a separation motor (not illustrated). By this, the separation roller pair 27 separates the medium P fed by the pickup roller 26 one sheet at a time.

The transport roller pair 30 rotates in accordance with driving of a transport motor (not illustrated). By this, the transport roller pair 30 transports the medium P toward the medium support section 31, which is downstream in the feed direction, along the feeding path 17a.

The recording section 24 performs recording on the medium P. The recording performed on the medium P is an example of a process performed on the medium P. The recording section 24 is an example of a process section that performs processing on the medium P.

The recording section 24 includes an ejection section 24h that performs recording by ejecting ink supplied from an ink tank (not illustrated) onto the medium P. The ejection section 24h is located on the +Z direction side of the medium support section 31 and is provided at a position facing the medium support section 31 with the feeding path 17a interposed therebetween in the Z-axial direction.

The recording section 24 causes ink to adhere to the medium P by ejecting ink from the ejection section 24h onto the medium P supported by the medium support section 31 based on the record data. By this, an image based on the record data is formed on the medium P.

The ejection section 24h included in the recording section 24 of the present embodiment is a so-called line head capable of simultaneously ejecting ink over the width direction of the medium P, which is the X-axial direction. The record data is data generated based on image data to be recorded on the medium P and is for causing the recording section 24 to execute recording. The image data includes text data and image data.

It should be noted that the recording section 24 is not limited to the inkjet type. The recording section 24 may be, for example, an electrophotographic type or an impact type.

The transport section 23 sends the medium P on which recording has been performed by the recording section 24 toward the medium discharge device 50 via the discharge path 17b. The transport section 23 includes a transport roller pair 4p in the discharge path 17b. The transport roller pair 4p rotates in accordance with drive of a transport motor (not illustrated). By this, the transport roller pair 4p transports the medium P downstream along the discharge path 17b.

The transport section 23 discharges the medium P on which recording was performed by the recording section 24 from the discharge port 5e via the discharge path 1e, and thereby places the medium P on the medium receiver 37. The transport section 23 includes a transport roller pair 4e in the discharge path 1e. The transport roller pair 4e rotates in accordance with the drive of a transport motor (not illustrated). By this, the transport roller pair 4e transports the medium P downstream along the discharge path 1e.

The transport section 23 includes a switching section 3e at a branch position that is between the discharge path 17b and the discharge path 1e.

The switching section 3e is rotated by, for example, a solenoid (not illustrated), and thus switches the transport destination of the medium P to a direction toward the downstream end of the discharge path 17b or a direction toward the discharge path 1e.

The transport section 23 includes the medium detection section 2e in the discharge path 17b at the branch position that is between the discharge path 17b and the discharge path 1e. As the medium detection section 2e, for example, a reflective photosensor can be used.

The medium detection section 2e detects whether or not medium P is present at the branch position that is between the discharge path 17b and the discharge path 1e. By this, the medium detection section 2e can detect whether or not the medium P has reached the switching section 3e.

For example, when the destination of the medium P is the direction toward the discharge port 5e, it is possible to judge whether or not the medium P has reached the discharge port 5e based on the transport time that elapsed after the medium detection section 2e detects the medium P.

Alternatively, when the transport destination of the medium P is a direction toward the discharge port 5e, it is possible to judge whether or not the medium P was discharged from the discharge port 5e based on the transport time that elapsed after the medium detection section 2e detected the medium P.

When the destination of the medium P is the downstream end of the discharge path 17b, it is possible to judge whether the medium P has been sent to the transport path 51 based on the elapsed transport time from when the medium detection section 2e detected the medium P.

The discharge path 1a is a transport path for discharging, from the discharge port 5a, the medium P that was sent out from the discharge path 17b. The discharge path 1a is a transport path coupling the discharge path 17b with the discharge port 5a.

The discharge port 5a is an opening that is provided on a side surface of the housing 13 on the +Y direction side and that is open in the +Y direction. The medium P discharged from the discharge port 5a is stacked on the medium tray 61a.

The discharge path 1b is a transport path that branches off from an intermediate section of the discharge path 1a and discharges the medium P sent from the discharge path 17b from the discharge port 5b. The discharge path 1b is a transport path coupling the discharge path 1a with the discharge port 5b.

The discharge port 5b is an opening that is provided on a side surface of the housing 13 on the +Y direction side and is open in the +Y direction. The discharge port 5b is disposed at an interval in the −Z direction with respect to the discharge port 5a. The medium P discharged from the discharge port 5b is stacked on the medium tray 61b.

The discharge path 1c is a transport path that branches off from an intermediate section of the discharge path 1b and discharges the medium P sent from the discharge path 17b from a discharge port 5c. The discharge path 1c is a transport path coupling the discharge path 1b with the discharge port 5c.

The discharge port 5c is an opening that is provided on a side surface of the housing 13 on the +Y direction side and that is open in the +Y direction. The discharge port 5c is disposed at an interval in the −Z direction with respect to the discharge port 5b. The medium P discharged from the discharge port 5c is stacked on a medium tray 61c.

The discharge path 1d is a transport path that branches off from an intermediate section of the discharge path 1c and that discharges the medium P that was sent from the discharge path 17b from the discharge port 5d. The discharge path 1d is a transport path coupling the discharge path 1c with the discharge port 5d.

The discharge port 5d is an opening that is provided on a side surface of the housing 13 on the +Y direction side and is open in the +Y direction. The discharge port 5d is arranged at an interval in the −Z direction with respect to the discharge port 5c. The medium P discharged from the discharge port 5d is stacked on the medium tray 61d.

The transport section 54 transports the medium P sent out from the discharge path 17b toward the discharge port 55 via the transport path 51. The transport section 54 includes the transport roller pairs 4p and 4a on the discharge path 1a.

The transport roller pair 4p is arranged at a position in the discharge path 1a that is upstream of the branch position that is between the discharge path 1a and the discharge path 1b. The transport roller pair 4a is provided in the discharge path 1a at a position between the discharge port 5a and the branch position of the discharge path 1a and the discharge path 1b.

The transport roller pairs 4p and 4a rotate in accordance with the drive of a discharge motor (not illustrated). By this, the transport roller pairs 4p and 4a transport the medium P downstream along the discharge path 1a.

The transport section 54 includes a switching section 3a at a branch position that is between the discharge path 1a and the discharge path 1b. The switching section 3a is rotated by, for example, a solenoid (not illustrated), in order to switch the transport destination of the medium P to a direction toward the discharge port 5a, which is a downstream end of the discharge path 1a, or a direction toward the discharge path 1b.

The transport section 54 includes the medium detection section 2a at the branch position that is between the discharge path 1a and the discharge path 1b. The medium detection section 2a detects whether or not medium P is present at the branch position that is between the discharge path 1a and the discharge path 1b. By this, the medium detection section 2a can detect whether or not the medium P has reached the switching section 3a.

For example, when the destination of the medium P is the direction toward the discharge port 5a, it is possible to judge whether or not the medium P has reached the discharge port 5a based on the transport time that elapsed after the medium detection section 2a detects the medium P.

Alternatively, when the transport destination of the medium P is a direction toward the discharge port 5a, it is possible to judge whether or not the medium P was discharged from the discharge port 5a based on the transport time that elapsed after the medium detection section 2a detects the medium P.

The transport section 54 includes transport roller pairs 4p and 4b on the discharge path 1b. The transport roller pair 4p is arranged in the discharge path 1b at a position upstream of a branch position that is between the discharge path 1b and the discharge path 1c. The transport roller pair 4b is arranged in the discharge path 1b at a position between the discharge port 5b and the branch position that is between the discharge path 1b and the discharge path 1c.

The transport roller pairs 4p and 4b rotate in accordance with the drive of a discharge motor (not illustrated). By this, the transport roller pairs 4p and 4b transport the medium P downstream along the discharge path 1b.

The transport section 54 includes a switching section 3b at the branch position that is between the discharge path 1b and the discharge path 1c. The switching section 3b is rotated by, for example, a solenoid (not illustrated), in order to switch the transport destination of the medium P to a direction toward the discharge port 5b, which is a downstream end of the discharge path 1b, or a direction toward the discharge path 1c.

The transport section 54 includes the medium detection section 2b at a branch position that is between the discharge path 1b and the discharge path 1c. The medium detection section 2b detects whether or not medium P is present at the branch position that is between the discharge path 1b and the discharge path 1c. By this, the medium detection section 2b can detect whether or not the medium P has reached the switching section 3b.

For example, when the destination of the medium P is the direction toward the discharge port 5b, it is possible to judge whether or not the medium P has reached the discharge port 5b based on the transport time that elapsed after the medium detection section 2b detected the medium P.

Alternatively, when the transport destination of the medium P is a direction toward the discharge port 5b, it is possible to judge whether or not the medium P is discharged from the discharge port 5b based on the transport time that elapsed after the medium detection section 2b detects the medium P.

The transport section 54 includes transport roller pairs 4p and 4c on the discharge path 1c. The transport roller pair 4p is arranged at a position in the discharge path 1c upstream of the branch position that is between discharge path 1c and the discharge path 1d. The transport roller pair 4c is arranged in the discharge path 1c at a position between the discharge port 5c and the branch position that is between the discharge path 1c and the discharge path 1d.

The transport roller pairs 4p and 4c rotate in accordance with the drive of a discharge motor (not illustrated). By this, the transport roller pairs 4p and 4c transport the medium P downstream along the discharge path 1c.

The transport section 54 includes a switching section 3c at the branch position that is between the discharge path 1c and the discharge path 1d. The switching section 3c is rotated by, for example, a solenoid (not illustrated), in order to switch the transport destination of the medium P to a direction toward the discharge port 5c, which is a downstream end of the discharge path 1c, or a direction toward the discharge path 1d.

The transport section 54 includes the medium detection section 2c at the branch position that is between the discharge path 1c and the discharge path 1d. The medium detection section 2c detects whether or not medium P is present at the branch position that is between the discharge path 1c and the discharge path 1d. By this, the medium detection section 2c can detect whether or not the medium P has reached the switching section 3c.

For example, when the destination of the medium P is the direction toward the discharge port 5c, it is possible to judge whether or not the medium P has reached the discharge port 5c based on the transport time that elapsed after the medium detection section 2c detects the medium P.

Alternatively, when the transport destination of the medium P is a direction toward the discharge port 5c, it is possible to judge whether or not the medium P is discharged from the discharge port 5c based on the transport time that elapsed after the medium detection section 2c detects the medium P.

The transport section 54 includes transport roller pairs 4p and 4d on the discharge path 1d. The transport roller pair 4d is arranged at a position between the transport roller pair 4p and the discharge port 5d in the discharge path 1d.

The transport roller pairs 4p and 4d rotate in accordance with the drive of a discharge motor (not illustrated). By this, the transport roller pairs 4p and 4d transport the medium P downstream along the discharge path 1d.

The transport section 54 includes the medium detection section 2d at a position between the transport roller pair 4p and the transport roller pair 4d in the discharge path 1d. The medium detection section 2d detects whether or not medium P is present at a position between the transport roller pair 4p and the transport roller pair 4d.

For example, it is possible to judge whether or not the medium P has reached the discharge port 5d based on the elapsed transport time from when the medium detection section 2d detected the medium P. Alternatively, it is possible to judge whether or not the medium P was discharged from the discharge port 5d based on the elapsed transport time from when the medium detection section 2d detected the medium P.

The medium discharge device 50 includes the mount section 56 on a side surface of the housing 13 on the +Y direction side. The medium tray 61 is detachably mounted on the mount section 56. The medium tray 61 is mounted on the mount section 56 from the +Y direction side of the mount section 56.

In the present embodiment, the four medium trays 61a, 61b, 61c, 61d as the medium tray 61 have the same aspect. The medium tray 61 includes an accommodation section 62, a restricted section 63, and a gripping section 64. The medium P is accommodated in the accommodation section 62.

The restricted section 63 is arranged at the end of the bottom surface of the medium tray 61 on the far side in the direction of mounting to the mount section 56. The restricted section 63 has, for example, a cylindrical shape when viewed from the direction along the X-axial direction. The restricted section 63 is restricted by a restriction section 57 of the mount section 56 (to be described later), and thus the removal of the medium tray 61 from the mount section 56 is restricted.

The gripping section 64 is provided at an end on the front side in the direction of mounting to the mount section 56 on the bottom surface of the medium tray 61. By gripping the gripping section 64, the user can easily detach the medium tray 61 from the mount section 56.

The mount section 56 of the present embodiment is configured by the mount sections 6a, 6b, 6c, and 6d, which have the same aspect. The four mount sections 6a, 6b, 6c, and 6d are arranged at positions corresponding to the four discharge ports 5a, 5b, 5c, and 5d. By this, the four mount sections 6a, 6b, 6c, and 6d are arranged in this order on the side surface of the housing 13 on the +Y direction side at intervals in the −Z direction from the +Z direction side.

The medium tray 61a is mounted on the mount section 6a. In the accommodation section 62 of the medium tray 61a mounted on the mount section 6a, the medium P discharged from the discharge port 5a is stacked in the +Z direction from the bottom surface of the accommodation section 62.

The medium tray 61b is mounted on the mount section 6b. In the accommodation section 62 of the medium tray 61b mounted on the mount section 6b, the medium P discharged from the discharge port 5b is stacked in the +Z direction from the bottom surface of the accommodation section 62.

The medium tray 61c is mounted on the mount section 6c. In the accommodation section 62 of the medium tray 61c mounted on the mount section 6c, the medium P discharged from the discharge port 5c is stacked in the +Z direction from the bottom surface of the accommodation section 62.

The medium tray 61d is mounted on the mount section 6d. In the accommodation section 62 on the medium tray 61d mounted on the mount section 6d, the medium P discharged from the discharge port 5d is stacked in the +Z direction from the bottom surface of the accommodation section 62.

The mount section 56 includes the restriction section 57, a sensor 58, and an object detection section 59. The restriction section 57 includes restriction sections 7a, 7b, 7c, and 7d, which have the same aspect, provided on the respective mount sections 6a, 6b, 6c, and 6d.

The sensor 58 includes sensors 8a, 8b, 8c and 8d, which have the same aspect, provided in the respective mount sections 6a, 6b, 6c, and 6d. The object detection section 59 includes object detection sections 9a, 9b, 9c, and 9d, which have the same aspect, provided in the respective mount sections 6a, 6b, 6c, and 6d.

The restriction section 57 is provided in the mount section 56 so as to restrict the removal of the medium tray 61 from the mount section 56. The restriction section 57 is provided closer to the end in the −Y direction than the center on the lower wall of the mount section 56 that supports the bottom surface of the medium tray 61 to be mounted.

In other words, the restriction section 57 is provided at the end of the lower wall of the mount section 56 on the far side in the direction of mounting the medium tray 61 to the mount section 56. In other words, the restriction section 57 is provided at a position on the upstream side of the center of the lower wall of the mount section 56 in the discharge direction in which the medium P is discharged to the medium tray 61.

For example, the restriction section 57 has a protrusion that can advance and retract in the Z-axial direction with respect to the restriction section main body by driving an actuator. As illustrated in FIG. 1, a protrusion protruding in the +Z direction from the restriction section main body of the restriction section 57 is located at a position adjacent to the restricted section 63 of the medium tray 61 in the +Y direction.

By this, the movement of the restricted section 63 in the +Y direction is restricted, and the removal of the medium tray 61 from the mount section 56 is restricted. Hereinafter, restricting the removal of the medium tray 61 set as a “stacking section” described later from the mount section 56 may be referred to as “restriction of removal of the stacking section.”

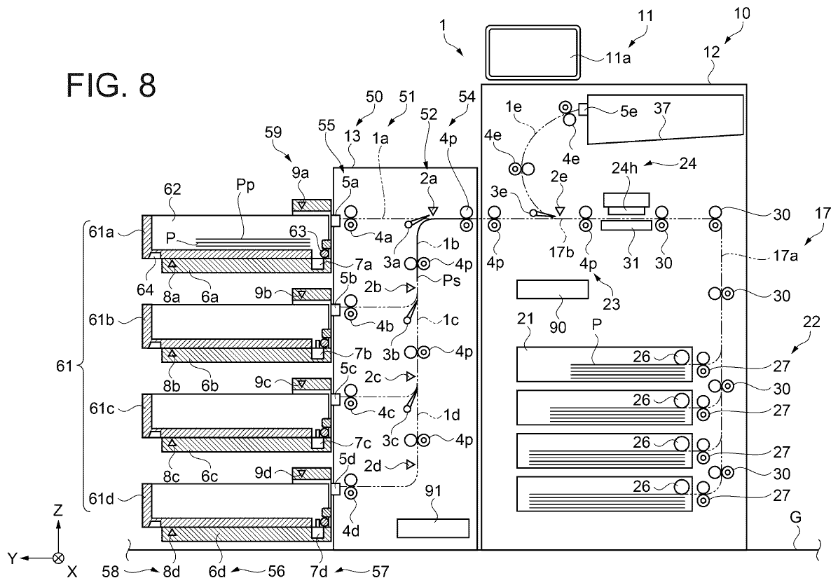

When the protrusion of the restriction section 57 is positioned inside the restricting section main body (refer to the restriction section 7a in FIG. 8), the movement of the restricted section 63 in the +Y direction is not restricted, and thus the medium tray 61 set as the “stacking section” can be removed from the mount section 56. By this, the “restriction of removal of the stacking section”by the restriction section 57 is released.

The sensor 58 is provided in the mount section 56 so as to be able to detect the displacement of the medium tray 61 with respect to the mount section 56. The sensor 58 is provided on the lower wall of the mount section 56 at a position closer to the end in the +Y direction than the center.

In other words, the sensor 58 is provided at the end on the front side in the direction of mounting the medium tray 61 to the mount section 56 on the lower wall of the mount section 56. In other words, the sensor 58 is provided at a position on the downstream side of the restriction section 57 in the discharge direction in which the medium P is discharged to the medium tray 61.

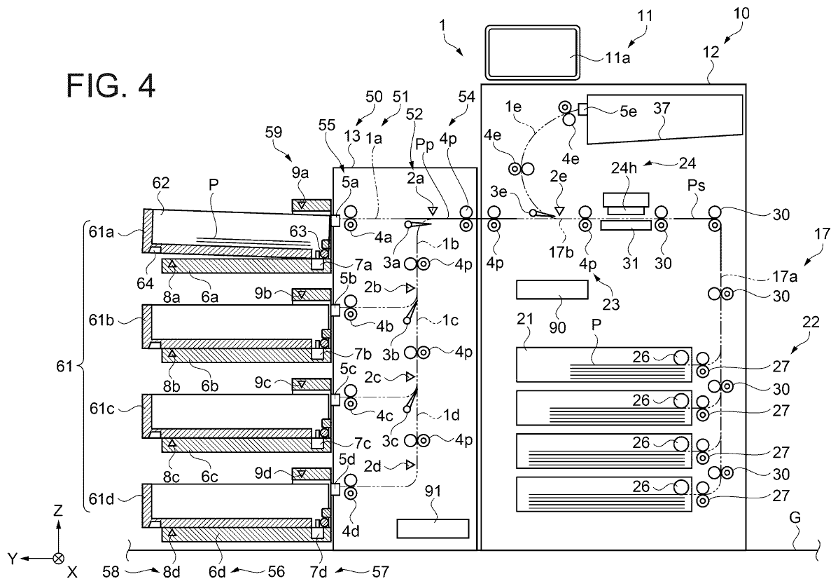

For example, assume that the user attempts to remove the medium tray 61a, which is mounted on the mount section 6a, from the mount section 6a. At this time, the medium tray 61a, which is mounted on the mount section 6a, is displaced from the mounted state shown in FIG. 1 to a posture in which, as shown in FIG. 4 for example, the bottom surface of the medium tray 61a is separated upward from the lower wall of the mount section 6a.

In this case, it can be inferred that the medium tray 61a is about to be removed from the mount section 6a based on the displacement of the medium tray 61a with respect to the mount section 6a detected by the sensor 8a.

In other words, the sensor 58 can detect a “removal operation of the stacking section” which is an operation for removing the medium tray 61 that was set as the “stacking section” from the mount section 56. The sensor 58 is an example of a detection section that detects the “removal operation of the stacking section.”

As the sensor 58, a mechanical sensor such as a reflective photosensor or a contact displacement sensor, a weight sensor, or the like can be adopted. The sensor 58 can also detect whether or not the medium tray 61 is mounted on the mount section 56.

The object detection section 59 is provided in the mount section 56 so as to be able to detect the position of the medium P accommodated in the accommodation section 62 of the medium tray 61. The object detection section 59 is provided at a position vertically above the accommodation section 62 of the medium tray 61 on the upper wall of the mount section 56 located above the medium tray 61 mounted on the mount section 56.

The object detection section 59 can detect a distance between the object detection section 59 and an object vertically below the object detection section 59. For example, when the medium P is stacked in the accommodation section 62 of the medium tray 61, the object detection section 59 detects a distance between the object detection section 59 and the uppermost sheet of medium P loaded in the accommodation section 62.

In this case, it is possible to estimate whether or not the medium P can be stacked on the medium tray 61 based on the distance between the object detection section 59 and the uppermost sheet of medium P stacked on the accommodation section 62 detected by the object detection section 59.

Alternatively, based on the distance between the object detection section 59 and the object vertically below the object detection section 59, it is possible to estimate that the object vertically below is the medium tray 61 and that no medium P is present in the accommodation section 62.

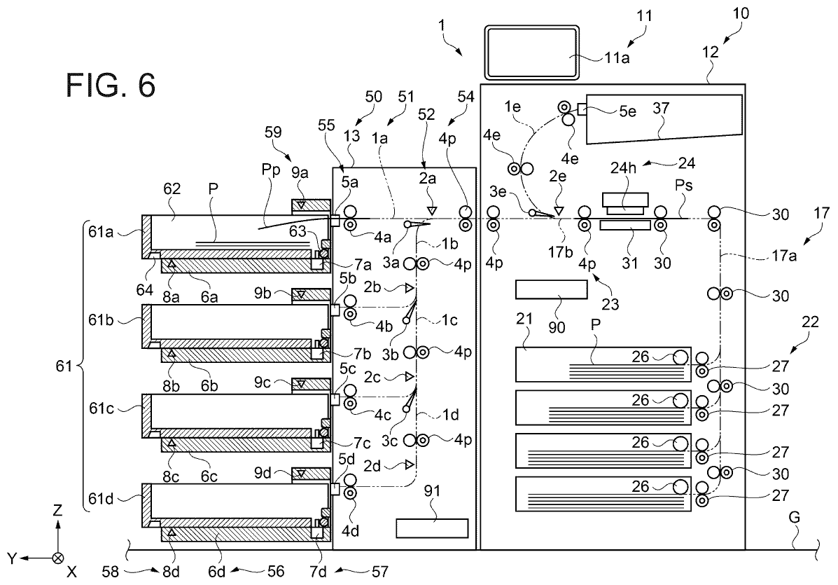

Alternatively, based on the distance between the object detection section 59 and the object vertically below the object detection section 59, it is possible to estimate that the object vertically below is the medium P (refer to the medium Pp in FIG. 6) being discharged from the discharge port 55.

Alternatively, based on the distance between the object detection section 59 and the object vertically below the object detection section 59, it is possible to estimate that the object vertically below is the mount section 56 and that the medium tray 61 is not mounted on the mount section 56.

The control sections 90 and 91 include a central processing unit (CPU), a storage section (not illustrated), and the like. The CPU can execute various programs stored in the storage section, and can perform various judgements, various commands, and the like.

The storage section stores, for example, various programs for performing driving control of the transport sections 22, 23, and 54, ejection control of the ejection section 24h in the recording section 24, and the like when recording is performed on the medium P. The storage section stores setting values, various tables, and the like.

The control sections 90 and 91 have a communication function between the control section 90 and the control section 91. By this, at least one of the control sections 90 and 91 can control each section included in the device main body 10. By this, at least one of the control sections 90 and 91 can control each section included in the medium discharge device 50.

For example, at least one of the control sections 90 and 91 performs recording on the medium P by performing drive control of the transport section 22, the recording section 24, and the like. For example, at least one of the control sections 90 and 91 controls the drive of the transport roller pair 4e and the switching section 3e provided in the discharge path 1e, thereby discharging the medium P from the discharge port 5e and placing the medium P on the medium receiver 37.

For example, at least one of the control sections 90 and 91 controls the drive of each section included in the device main body 10 and the medium discharge device 50. By this, at least one of the control sections 90 and 91 performs recording on the medium P and discharges the recorded medium P to the medium tray 61 via the transport paths 17, 51 and the discharge port 55.

The medium processing device 1 may include the control section 90 in the housing 13 of the medium discharge device 50. In this case, the control section 90 performs drive control of each section included in the device main body 10 and the medium discharge device 50. In this case, the medium processing device 1 may not include the control section 91.

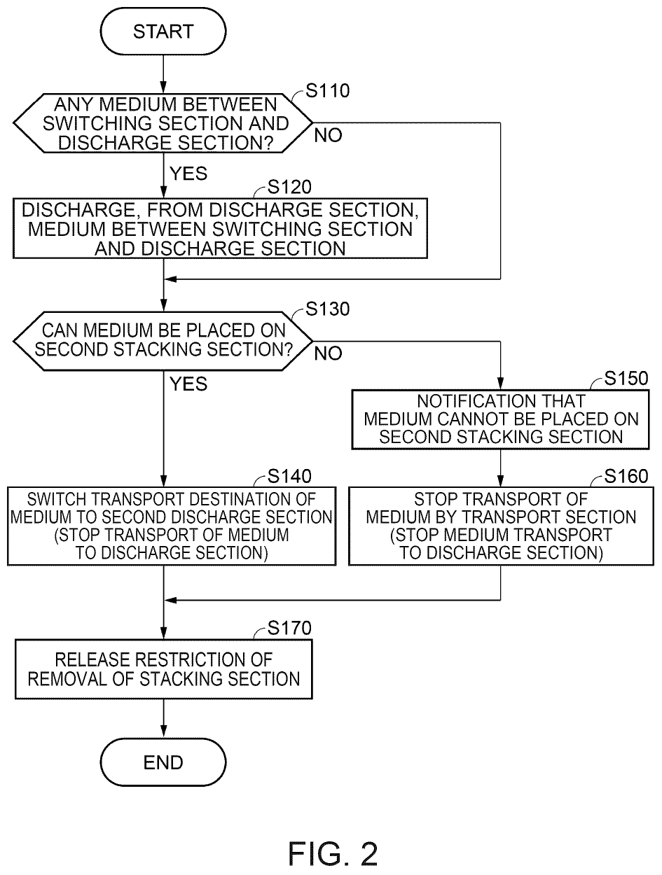

Next, a process performed by the control sections 90 and 91 in a case where the sensor 58 detects the “removal operation of the stacking section” when the medium P is transported will be described with reference to the flowchart illustrated in FIG. 2. The flow of the process performed by the control sections 90 and 91 when the sensor 58 detects the “removal operation of the stacking section” corresponds to a control method of the medium discharge device 50.

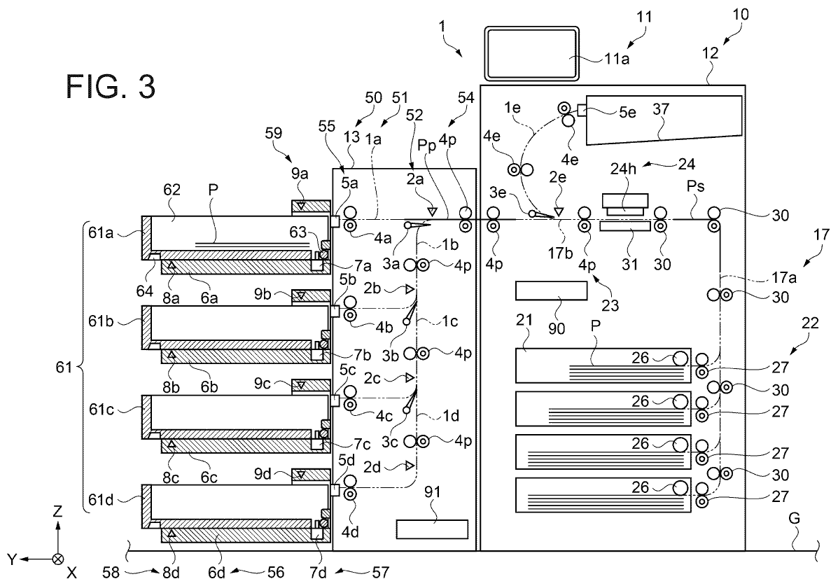

In the following description, it is assumed that the medium P is transported in the medium processing device 1 as illustrated in FIG. 3. Among the medium P being transported, in FIG. 3, the preceding medium P on the transport path 51 may be referred to as a medium Pp, and the subsequent medium P on the transport path 17 may be referred to as a medium Ps.

In the following description, it is assumed that the medium tray 61a is set as the “stacking section” and the medium tray 61b is set as the “second stacking section.” The “stacking section” is a discharge destination of the medium P to which the transported medium P is preferentially discharged, and to which one of the medium trays 61 that can be detached from the mount section 56 is set.

The “second stacking section” is a discharge destination of the medium P selected when the medium P is not discharged to the “stacking section,” and to which one of the medium trays 61 that are not set as the “stacking section”is set.

The settings of the “stacking section” and the “second stacking section” can be set by the user operating the reception section 11, but in a case where there is no setting by the user, the settings of the “stacking section” and the “second stacking section” set in advance are applied.

When the medium tray 61a is set as the “stacking section,” the mount section 6a on which the medium tray 61a is mounted corresponds to the “mount section” on which the “stacking section” in which the medium P can be stacked is detachably mounted. When the medium tray 61a is set as the “stacking section,” the discharge port 5a, which is the transport destination of the medium P, corresponds to the “discharge section” that discharges the medium P to the “stacking section.”

When the medium tray 61b is set as the “second stacking section”, the mount section 6b on which the medium tray 61b is mounted corresponds to the “second mount section” on which the “second stacking section” on which the medium P can be stacked is detachably mounted. When the medium tray 61b is set as the “second stacking section,” the discharge port 5b, which is the transport destination of the medium P, corresponds to a “second discharge section” that discharges the medium P to the “second stacking section.”

For example, as shown in FIG. 4, when the medium P is being transported, if the medium tray 61a is displaced by the user attempting to remove the medium tray 61a, the displacement of the medium tray 61a is detected by the sensor 8a.

When the displacement of the medium tray 61a is detected by the sensor 8a, the control sections 90 and 91 judge that a “removal operation of the stacking section” is detected.

In this case, in step S110, the control sections 90 and 91 confirms whether or not the medium P is present between the switching section 3a and the discharge port 5a.

In detail, the control sections 90 and 91 confirm whether or not the medium P has reached the switching section 3a based on the detection result of the medium P by the medium detection section 2a. Further, the control sections 90 and 91 confirm whether or not the medium P has reached the discharge port 5a based on the transport time that elapsed after the medium detection section 2a detects the medium P.

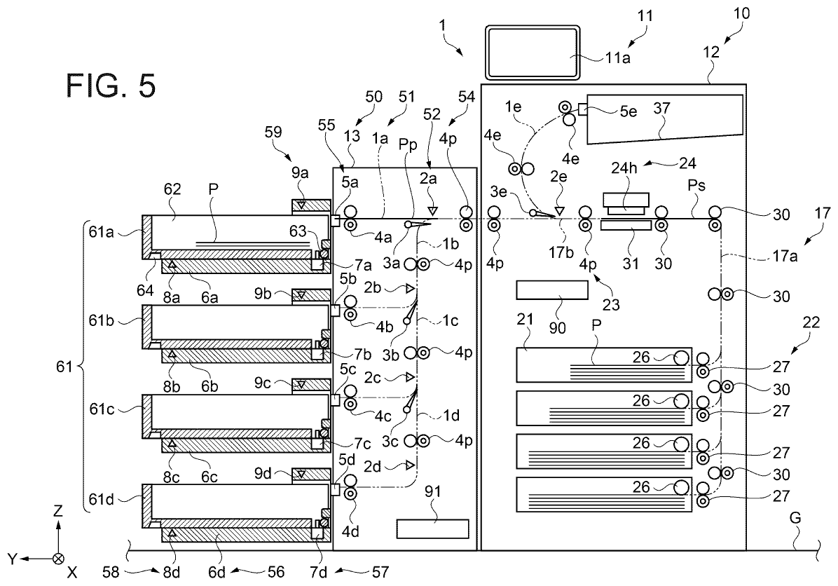

When the medium Pp has reached the switching section 3a as illustrated in FIG. 4, or when the medium Pp has reached the discharge port 5a as illustrated in FIG. 5, the judgement result in step S110 is YES, and the control sections 90 and 91 advance the process to step S120.

When there is no medium Pp in the discharge path 1a between the switching section 3a and the discharge port 5a, the judgement in step S110 is NO, and the control sections 90 and 91 advance the process to step S130.

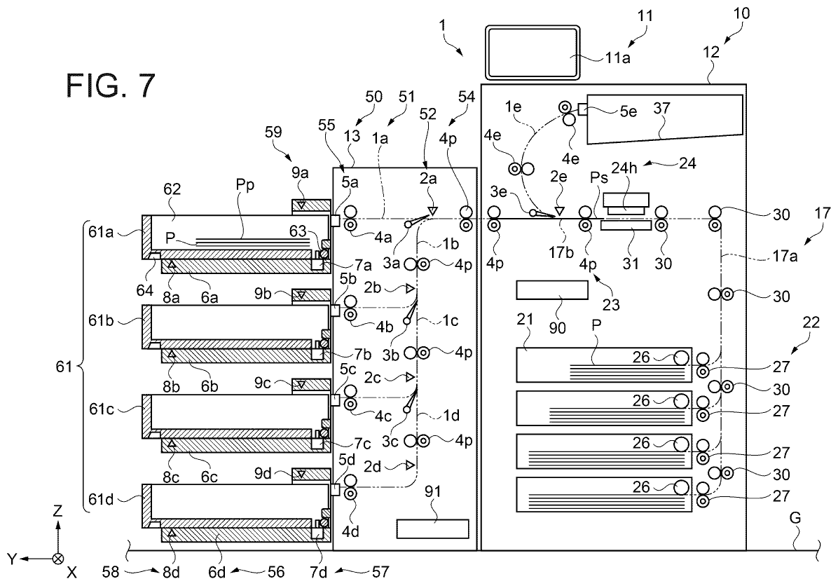

In step S120, the control sections 90 and 91 discharge, from the discharge port 5a, the medium Pp that is between the switching section 3a and the discharge port 5a. In detail, as illustrated in FIGS. 6 and 7, the control sections 90 and 91 control the transport roller pairs 4p and 4a to discharge, to the medium tray 61a, the medium Pp that is between the switching section 3a and the discharge port 5a in the discharge path 1a.

When the process of step S120 is completed, the control sections 90 and 91 advance the process to step S130.

In step S130, the control sections 90 and 91 confirm whether or not the medium P can be placed on the “second stacking section.” In detail, the control sections 90 and 91 confirm whether or not the medium P can be placed on the medium tray 61b based on the detection result of the object detection section 9b.

When the medium P can be placed in the accommodation section 62 of the medium tray 61b, the judgement result in step S130 is YES, and the control section 90 and 91 advance the process to step S140.

For example, when a plurality of medium trays 61b, 61c, and 61d that are not set as the “stacking section” are set as the “second stacking section,” the control sections 90 and 91 confirm in step S130 whether or not the medium P can be placed on any of the medium trays 61b, 61c, and 61d.

For example, it is assumed that the medium P cannot be placed on the medium tray 61b, and the medium P can be placed on the medium tray 61c. In this case, the control sections 90 and 91 set the medium tray 61c to the “second stacking section,” determine step S130 to be YES, and then advance the processing to step S140. In this case, the discharge port 5c that discharges the medium P to the medium tray 61c corresponds to the “second discharge section.”

Alternatively, it is assumed that the medium P cannot be placed on the medium tray 61b, and the medium P can be placed on the medium trays 61c and 61d. In this case, the control sections 90 and 91 sets the medium tray 61c or 61d that is set with a higher priority as the “second stacking section,” and then determines step S130 to be YES, and advances the process to step S140.

In this case, one of the discharge ports 5c or 5d, which discharges the medium P to either of the medium trays 61c or 61d set as the “second stacking section,” corresponds to the “second discharge section.” When the priorities are not set by the user, the control sections 90 and 91 set one of the medium trays 61c and 61d as the “second stacking section” according to the priorities set in advance.

In step S140, the control sections 90 and 91 switches the transport destination of the medium P to the second discharge section. Specifically, by configuring the switching sections 3a and 3b in the aspect shown in FIG. 7, the control sections 90 and 91 switch the transport destination of the medium P to the discharge port 5b.

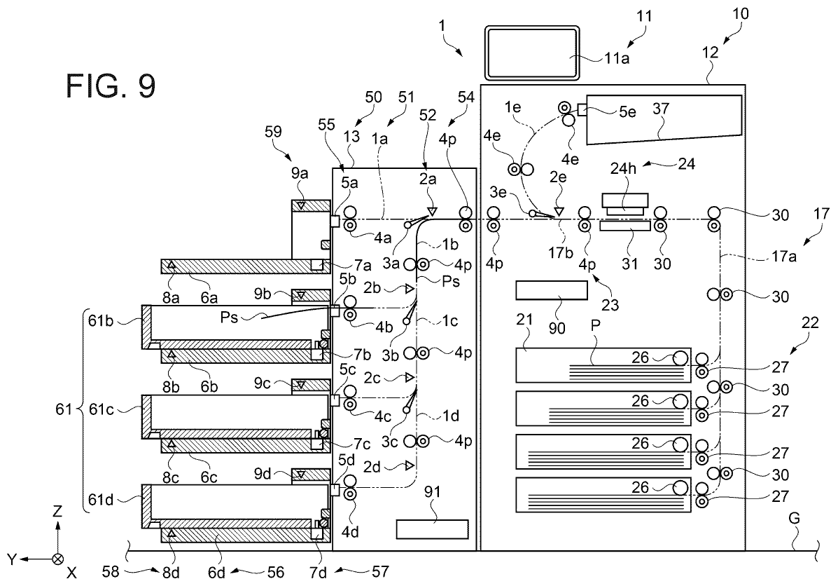

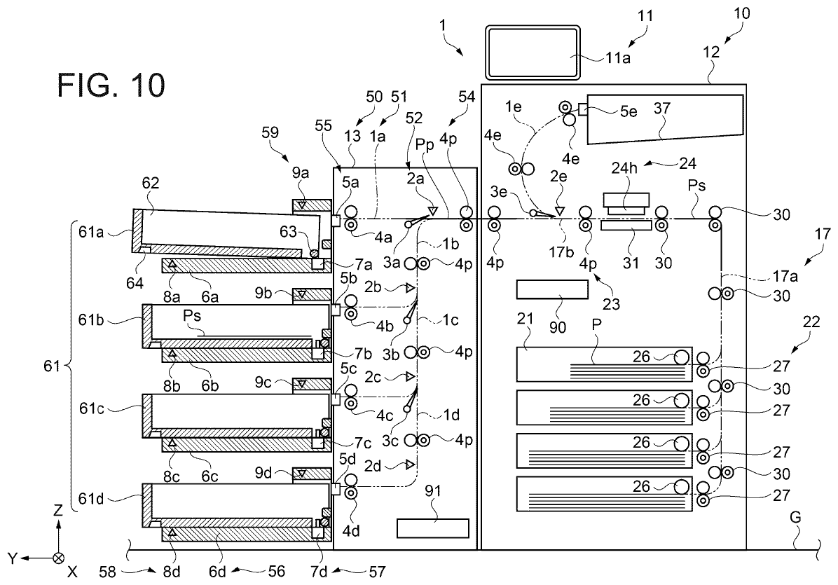

By this, transport of the medium P to the discharge port 5a is stopped, and the medium Ps is transported toward the discharge port 5b as illustrated in FIG. 8. The medium Ps transported toward the discharge port 5b are discharged to the accommodation section 62 on the medium tray 61b as shown in FIGS. 9 and 10.

When the process of step S140 is completed, the control sections 90 and 91 advance the process to step S170.

When the medium P cannot be placed on the medium tray 61b, the judgement in step S130 is NO, and the control sections 90 and 91 advance the process to step S150. Note that, the phrase “the medium P cannot be placed on the medium tray 61b” includes not only the case where there is no room in the accommodation section 62 of the medium tray 61b to accommodate the medium P, but also the case where the medium tray 61b is not mounted on the mount section 6b.

In step S150, the control sections 90 and 91 perform notification that the medium P cannot be placed on the “second stacking section.” In detail, the control sections 90 and 91 control the reception section 11 to notify that the medium P cannot be placed on the medium tray 61b.

When the medium tray 61b is not mounted, the control sections 90 and 91 perform notification to prompt mounting of the medium tray 61b on the mount section 6b. When the medium P is already placed on the medium tray 61b, the control sections 90 and 91 perform notification to prompt removal of the medium P from the medium tray 61b.

When the process of step S150 is completed, the control sections 90 and 91 advance the process to step S160. It is assumed that, for example, in response to a notification in step S150 indicating that the medium P cannot be placed on the “second stacking section,” the user performs an operation such as reassigning either of the medium trays 61c or 61d as the “second stacking section.”

In this case, the control sections 90 and 91 may perform step S130 process again based on an instruction from the user.

For example, it is assumed that a plurality of medium trays 61b, 61c, and 61d that are not set as the “stacking section” are set as the “second stacking section.” In this case, when the medium P cannot be placed on any medium tray 61 amongst the medium trays 61b, 61c, and 61d, the judgement in step S130 may be NO.

In this case, in step S150, the control sections 90 and 91 may control the reception section 11 to perform notification that the medium P cannot be placed on the medium tray 61. When the medium tray 61 is not mounted, the control sections 90 and 91 may perform notification to prompt the user to mount one of the medium trays 61b, 61c, and 61d in one of the mount sections 6b, 6c, and 6d.

In a case where the medium P is already placed on the medium tray 61, the control sections 90 and 91 may perform notification to prompt removal of the medium P from one of the medium trays 61b, 61c, and 61d.

In step S160, the control sections 90 and 91 stop transport of the medium P by the transport section 22, 23 and 54. Specifically, transport of the medium P in the transport path 17 and 51 is stopped by controlling drive of the transport sections 22, 23, and 54.

By this, transport of the medium P to the discharge port 5a is stopped. When the process of step S160 is completed, the control sections 90 and 91 advance the process to step S170.

Step S160 is not necessarily performed. After the notification is performed in step S150, discharge of the medium P to the “stacking section” may be continued until the medium P can be stacked on the “second stacking section.”

Alternatively, the user may be asked whether or not to execute step S160. In other words, the user may be asked whether to execute step S160 or continue discharge of the medium P to the “stacking section.”

In step S170, the control sections 90 and 91 release “restriction of removal of the stacking section” after a predetermined time has elapsed since discharge of the medium P from the discharge port 5a is stopped. To be specific, as illustrated in FIG. 8, the control sections 90 and 91 control the restriction section 7a to position the protrusion of the restriction section 7a inside the main body of the restriction section 7a.

By this, the control sections 90 and 91 release restriction of removal of the medium tray 61a by the restriction section 7a When the process of step S170 is completed, the control sections 90 and 91 end the process in a case where the sensor 58 detects the “removal operation of the stacking section” when the medium P is transported.

As shown in FIG. 8, when the restriction on removal of the medium tray 61a by the restriction section 7a is released, the user becomes able to remove the medium tray 61a from the mount section 6a. As shown in FIG. 9, after the medium tray 61a is removed from the mount section 6a, the sensor 8a or the object detection section 9a does not detect that the medium tray 61a is mounted on the mount section 6a.

In this case, the state in which the restriction on the removal of the medium tray 61a by the restriction section 7a is released is maintained. By this, as shown in FIG. 10, the medium tray 61a is maintained in a state in which it can be mounted on the mount section 6a.

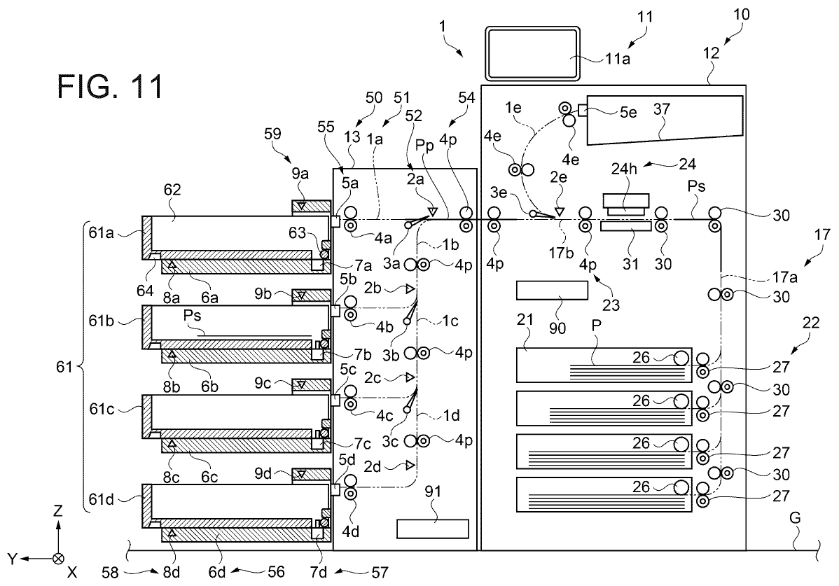

As shown in FIG. 11, when the medium tray 61a is mounted to the mount section 6a, the sensor 8a or the object detection section 9a detects that the medium tray 61a is mounted on the mount section 6a.

In this case, the control sections 90 and 91 control the restriction section 7a to cause the protrusion of the restriction section 7a to protrude from the restriction section main body in the +Z direction (see FIG. 7). By this, it restricts the medium tray 61a from being removed from the mount section 6a.

The restriction of the removal of the medium tray 61a from the mount section 6a by the restriction section 7a may be performed by the control sections 90 and 91 controlling the restriction section 7a based by the control sections 90 and 91 on the input from the reception section 11 by the user.

When the medium tray 61a is set as the “stacking section,” the medium receiver 37 may be set as the “second stacking section.” When the medium receiver 37 is set to the “second stacking section,” the discharge port 5e corresponds to a “second discharge section” that discharges the medium P to the “second stacking section.”

In this embodiment, in step S110, the control sections 90 and 91 confirm whether or not the medium Pp has reached the switching section 3e based on the detection result of the medium P by the medium detection section 2e. Further, the control sections 90 and 91 confirm whether or not the medium Pp has reached the discharge port 5a based on the transport time that elapsed after the medium detection section 2e detects the medium P.

In this embodiment, in step S130, the control sections 90 and 91 confirm whether or not the medium P can be placed on the medium receiver 37.

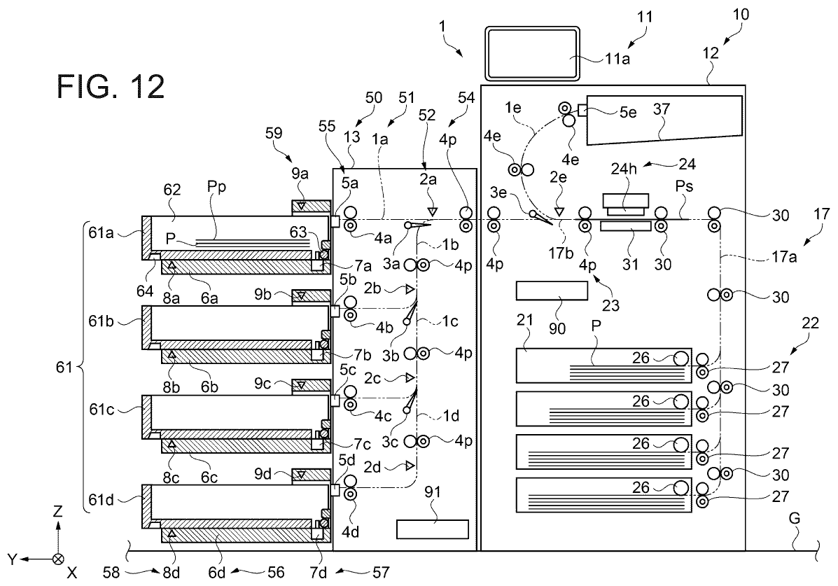

In this embodiment, in step S140, the control sections 90 and 91 switches the transport destination of the medium P to the discharge port 5e by setting the switching sections 3a and 3e to the aspect illustrated in FIG. 12.

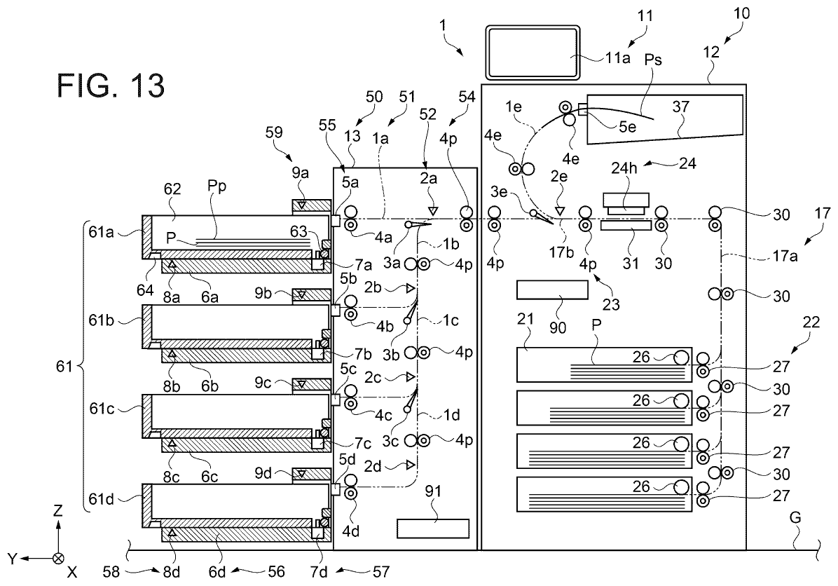

By this, transport of the medium P to the discharge port 5a is stopped, and the subsequent medium Ps is transported toward the discharge port 5e. The subsequent medium Ps is transported toward the discharge port 5e and discharged to the medium receiver 37 as illustrated in FIG. 13.

In this embodiment, in step S150, the control sections 90 and 91 control the reception section 11 to perform notification that the medium P cannot be placed on the medium receiver 37.

As described above, according to the medium discharge device 50, the medium processing device 1, and the control method of the medium discharge device 50 according to the embodiment, the following effects can be obtained.

The medium discharge device 50 includes a mount section 6a, on which the medium tray 61a for stackable medium P is detachably mountable. The medium discharge device 50 includes the discharge port 5a that ejects the medium P to the medium tray 61a mounted on the mount section 6a. The medium discharge device 50 includes a detection section that detects the “removal operation of the stacking section” for removing the medium tray 61a from the mount section 6a. The medium discharge device 50 includes the restriction section 7a that can perform “restriction of removal of the stacking section” that restricts removal of the medium tray 61a from the mount section 6a. The medium discharge device 50 includes control sections 90 and 91. When the detection section detects the “removal operation of the stacking section,” the control sections 90 and 91 releases the “restriction of removal of the stacking section” by the restriction section 7a after discharge of the medium P from the discharge port 5a is stopped.

This enables the user to remove the medium tray 61a from the mount section 6a at an arbitrary timing. Furthermore, since the “restriction of removal of the stacking section” by the restriction section 7a is released after discharge of the medium P from the discharge port 5a is stopped, it is possible to suppress the medium P from being discharged in a state where the medium tray 61a is not present.

The detection section is a sensor 8a that detects the “removal operation of the stacking section.” This eliminates the need for the user to perform a special operation, and thus improves usability.

The sensor 8a is provided downstream of the restriction section 7a in the discharge direction in which the medium P is discharged to the medium tray 61a.

According to this configuration, the displacement of the medium tray 61a at the position of the sensor 8a when the user attempts to remove the medium tray 61a is likely to be large compared to a case where the sensor 8a is provided upstream of the restriction section 7a. Therefore, the sensor 8a can easily detect the removal operation of the stacking section.

The control sections 90 and 91 stop discharge of the subsequent medium Ps from the discharge port 5a after completion of the discharge, from the discharge port 5a, of the medium Pp that reached the discharge port 5a at the time that the detection section detected the “removal operation of the stacking section.”

Accordingly, the medium Pp that is about to be discharged is discharged from the discharge port 5a, and thus it is possible to prevent the medium Pp from stopping in an incomplete state. In particular, if the medium Pp protrudes above the medium tray 61a, there is a risk of the medium Pp becoming an obstacle when the medium tray 61a is attached or detached, but such a situation can be suppressed.

The control sections 90 and 91 release the “restriction of removal of the stacking section” by the restriction section 7a after a predetermined time has elapsed since the discharge of the medium Pp from the discharge port 5a is stopped.

This configuration can more reliably prevent the medium Pp from being discharged without the medium tray 61a. In particular, when the medium Pp is discharged from the discharge port 5a and drops down, the medium tray 61a can be prevented from being removed while the medium Pp drops down by ensuring the time for the fall.

The medium discharge device 50 further includes the medium tray 61a. This enables the user to remove the medium tray 61a from the mount section 6a at an arbitrary timing.

The medium discharge device 50 further includes the mount section 6b to which is detachably mounted the medium tray 61b on which the medium P is stacked. The medium discharge device 50 further includes the discharge port 5b that discharges the medium P to the medium tray 61b mounted on the mount section 6b. The medium discharge device 50 further includes the transport section 54 that can transport the medium P to the discharge port 5a and the discharge port 5b. The medium discharge device 50 further includes the switching sections 3a and 3b that switch the transport destination of the medium P by the transport section 54 between the discharge port 5a and the discharge port 5b. When the detection section detects the “removal operation of the stacking section,” the control sections 90 and 91 switch the transport destination of the medium P to the discharge port 5b by the switching sections 3a and 3b. In addition, the control sections 90 and 91 release the “restriction of removal of the stacking section” by the restriction section 7a after stopping the discharge of the medium P from the discharge port 5a.

By this, in addition to stopping the discharge of the medium P from the discharge port 5a, the transport destination of the medium P is switched to the discharge port 5b, and thus discharge of the medium P can be continued. Therefore, the user can detach the medium tray 61a from the mount section 6a at an arbitrary timing while suppressing a decrease in throughput.

Furthermore, since the “restriction of removal of the stacking section” by the restriction section 7a is released after discharge of the medium P from the discharge port 5a is stopped, it is possible to suppress the medium P from being discharged in a state where the medium tray 61a is not present.

The control sections 90 and 91 stop the discharge of the subsequent medium Ps from the discharge port 5a after completion of the discharge from the discharge port 5a of the medium Pp that reached the switching section 3a at the time when the detection section detected the “removal operation of the stacking section.”

By this, the medium Pp is discharged from the discharge port 5a when the switching of the transport destination of the medium P is not in time, and thus it is possible to suppress the medium Pp from stopping in an incomplete state. In particular, it is possible to suppress the order of print jobs from being changed when print jobs are ordered. In particular, if the medium Pp protrudes above the medium tray 61a, there is a risk of the medium Pp becoming an obstacle when the medium tray 61a is attached or detached, but such a situation can be suppressed.

When the detection section detects the “removal operation of the stacking section” and the medium P can be stacked on the medium tray 61b, the control sections 90 and 91 switch the transport destination of the medium P to the discharge port 5b by the switching sections 3a and 3b. In addition, the control sections 90 and 91 release the “restriction of removal of the stacking section” by the restriction section 7a after stopping the discharge of the medium P from the discharge port 5a.

By this, since the medium P can be stacked on the medium tray 61b which is the discharge destination of the medium P, the discharge of the medium P can be continued.

When the detection section detects the “removal operation of the stacking section” and the medium P cannot be stacked on the medium tray 61b, the control sections 90 and 91 stop transport of the medium P by the transport section 54. In addition, the control sections 90 and 91 release the “restriction of removal of the stacking section” by the restriction section 7a after stopping the discharge of the medium P from the discharge port 5a.

By this, when the medium tray 61b cannot be stacked the medium P, transport of the medium P by the transport section 54 is stopped, and thus it is possible to suppress transport failure of the medium P.

The medium discharge device 50 further includes the medium tray 61b. This enables the user to remove the medium tray 61a from the mount section 6a at an arbitrary timing while suppressing a decrease in throughput.

The medium discharge device 50 further includes the medium receiver 37 on which the medium P is stacked. The medium discharge device 50 further includes the discharge port 5e through which the medium P is discharged to the medium receiver 37. The medium discharge device 50 further includes transport sections 23 and 54 capable of transporting the medium P to the discharge port 5a and the discharge port 5e. The medium discharge device 50 further includes switching sections 3a and 3e that switch the destination of the medium P transported by the transport sections 23 and 54 between the discharge port 5a and the discharge port 5e. When the detection section detects the “removal operation of the stacking section,” the control sections 90 and 91 switches the transport destination of the medium P to the discharge port 5e by the switching sections 3a and 3e. In addition, the control sections 90 and 91 release the “restriction of removal of the stacking section” by the restriction section 7a after stopping the discharge of the medium P from the discharge port 5a.

By this, in addition to stopping the discharge of the medium P from the discharge port 5a, the transport destination of the medium P is switched to the discharge port 5e, and thus the discharge of the medium P can be continued. Therefore, the user can detach the medium tray 61a from the mount section 6a at an arbitrary timing while suppressing a decrease in throughput.

The medium processing device 1 includes a recording section 24 that performs recording on the medium P, and the medium discharge device 50 that discharges the medium P on which recording has been performed by the recording section 24. By this, the medium processing device 1 may have the effects of the medium discharge device 50.

The method for controlling the medium discharge device 50 is a method for controlling the medium discharge device 50 including the mount section 6a onto which is detachably mounted the medium tray 61a on which the medium P is stacked and the discharge port 5a that discharges the medium P to the medium tray 61a mounted on the mount section 6a. The method of controlling the medium discharge device 50 includes stopping discharging of the medium P from the discharge port 5a when the “removal operation of the stacking section” for removing the medium tray 61a from the mount section 6a is detected. The method of controlling the medium discharge device 50 includes releasing the “restriction of removal of the stacking section” that restricts removal of the medium tray 61a from the mount section 6a after stopping discharging of the medium P from the discharge port 5a.

This enables the user to remove the medium tray 61a from the mount section 6a at an arbitrary timing. Furthermore, since the “restriction of removal of the stacking section” is released after the discharge of the medium P from the discharge port 5a is stopped, it is possible to suppress the medium P from being discharged in a state where the medium tray 61a is not present.

The medium discharge device 50 according to the above-described embodiment of the present disclosure basically has the configuration as described above, but it is needless to say that a partial configuration can be changed or omitted within a range not departing from the gist of the present disclosure.

The medium processing device 1 according to the above-described embodiment of the present disclosure basically has the configuration as described above, but it is needless to say that a partial configuration can be changed or omitted within a range not departing from the gist of the present disclosure.

The control method of the medium discharge device 50 according to the above-described embodiment of the present disclosure basically has the configuration as described above, but it is of course possible to perform a change, omission, or the like of a partial configuration within a range not departing from the gist of the present disclosure.

The above embodiment and other embodiments described below can be implemented in combination with each other within a technically consistent range. Other embodiments are described below.

In the above embodiment, the medium trays 61b, 61c, and 61d may not be provided so as to be attachable to and detachable from the mount sections 6b, 6c, and 6d. In this case, the medium trays 61b, 61c, and 61d may be provided integrally with the mount sections 6b, 6c, and 6d. In this case, the medium discharge device 50 includes the medium trays 61b, 61c, and 61d in the housing 13.

In the above embodiment, the medium discharge device 50 may not include the mount sections 6b, 6c, and 6d to which the medium trays 61b, 61c, and 61d can be mounted.

In the above embodiment, the control sections 90 and 91 may judge that the “removal operation of the stacking section” has been detected when the reception section 11 receives an input indicating that the medium tray 61a set as the “stacking section” is desired to be removed. In this case, the reception section 11 is an example of a detection section that detects the “removal operation of the stacking section.” According to this embodiment, the following effects can be obtained.

The detection section is the reception section 11 that receives an input for removing the medium tray 61a. This configuration can increase the time to stop discharging the medium P from the discharge port 5a, which is the discharge section, before the user actually removes the medium tray 61a set as the stacking section.

In the above embodiment, the sensor 8a does not have to detect the displacement of the medium tray 61a set in the “stacking section.” For example, sensor 8a may detect a user gripping medium tray 61a. In this case, the control sections 90 and 91 may judge that the “removal operation of the stacking section” is detected when the sensor 8a detects that the user grips the medium tray 61a.

In this embodiment, for example, the gripping section 64 may be displaced by being gripped by the user. For example, the sensor 8a in present embodiment is provided on the mount section 6a so as to be able to detect the displacement of the gripping section 64.

In this case, the sensor 8a detects the gripping of the medium tray 61a by the user by detecting the displacement of the gripping section 64. The control sections 90 and 91 in present embodiment judge that the “removal operation of the stacking section” has been detected when the sensor 8a detects the displacement of the gripping section 64 by the user's gripping.

In the above embodiment, the detection section may not be the sensor 8a that detects the displacement of the medium tray 61a set in the “stacking section.” For example, the medium discharge device 50 may include a motion sensor that can detect the approach of a user to the medium tray 61a.

The control sections 90 and 91 in present embodiment judge that the “removal operation of the stacking section” is detected when the motion sensor detects the approach of the user to the medium tray 61a. In this case, the motion sensor is an example of a detection section that detects the “removal operation of the stacking section.” As the motion sensor, a sensor that detects movement or heat of a human in a surrounding environment by using infrared rays, ultrasonic waves, microwaves, or the like can be adopted.

In the above embodiment, the medium processing device 1 may have an operating button that the user operates when the user wants to remove the medium tray 61a set to the “stacking section.” For example, the operation button may be disposed on the housing 13 of the medium discharge device 50 or may be arranged on the mount section 6a. Alternatively, the operation button may be arranged on the medium tray 61a.

In present embodiment, the control sections 90 and 91 judge that the “removal operation of the stacking section” has been detected when the operation button is operated. In this case, the operation button is an example of a detection section that detects the “removal operation of the stacking section.” In this embodiment, the sensor 8a may be absent.

In the above-described embodiment, the medium processing device 1 may include a drying section that dries the medium P.

In this case, the medium discharge device 50 discharges the medium P dried by the drying section. The drying performed on the medium P by the drying section is an example of a process performed on the medium P, and the drying section is an example of a process section. In this case, the medium processing device 1 may not include the recording section 24.

In the above embodiment, the medium processing device 1 may include a post-process section that performs post-processing on the medium P. In this case, the medium discharge device 50 discharges the medium P subjected to the post-processing by the post-process section. The post-processing performed on the medium P by the post-process section is an example of processing performed on the medium P, and the post-process section is an example of a process section. In this case, the medium processing device 1 may not include the recording section 24.

In the above-described embodiment, the medium processing device 1 may include a pre-process section that performs pre-processing on the medium P. In this case, the medium discharge device 50 discharges the medium P that has been subjected to the pre-processing by the pre-process section. The pre-processing performed on the medium P by the pre-process section is an example of processing performed on the medium P, and the pre-process section is an example of a process section. In this case, the medium processing device 1 may not include the recording section 24.

In the above embodiment, the medium processing device 1 may include a reading section that performs reading processing to read an image recorded on the medium P. In this case, the medium discharge device 50 discharges the medium P on which the reading process has been performed by the reading section. The reading process performed on the medium P by the reading section is an example of a process performed on the medium P, and the reading section is an example of a process section. In this case, the medium processing device 1 may not include the recording section 24.

In the above embodiment, the order of the steps of the flowchart shown in FIG. 2 may be changed as desired. In the above embodiment, a plurality of steps in the flowchart shown in FIG. 2 may be executed simultaneously.

For example, step S130 may be executed before step S110. At this time, the process may proceed to step S110 when step S130 is YES.

What is claimed is:

1. A medium discharge device comprising:
a mount section to which is detachably mountable a stacking section on which a medium is stackable;
a discharge section that discharges the medium to the stacking section mounted on the mount section;
a detection section configured to detect a removal operation of the stacking section from the mount section;
a restriction section configured to restrict removal of the stacking section from the mount section; and
a control section, wherein
when the detection section detects the removal operation of the stacking section, then after stopping discharge of the medium from the discharge section, the control section releases restriction of removal of the stacking section by the restriction section.

2. The medium discharge device according to claim 1, wherein
the detection section is a sensor that detects a removal operation of the stacking section.

3. The medium discharge device according to claim 2, wherein
the sensor is provided downstream of the restriction section in a discharge direction in which the medium is discharged to the stacking section.

4. The medium discharge device according to claim 1, wherein
the detection section is a reception section that receives an input for detaching the stacking section.

5. The medium discharge device according to claim 1, wherein
the control section stops discharge of subsequent medium from the discharge section after completion of discharge from the discharge section of the medium that reached the discharge section at a time that the detection section detected the removal operation of the stacking section.

6. The medium discharge device according to claim 1, wherein
the control section releases the restriction of removal of the stacking section by the restriction section after a predetermined time has elapsed from when the discharge of the medium from the discharge section was stopped.

7. The medium discharge device according to claim 1, further comprising:
the stacking section.

8. The medium discharge device according to claim 1, further comprising:
a second mount section to which is detachably mountable a second stacking section on which the medium is stacked;
a second discharge section that discharges the medium to the second stacking section mounted on the second mount section;
a transport section configured to transport the medium to the discharge section and to the second discharge section; and
a switching section that switches a transport destination of the medium by the transport section between the discharge section and the second discharge section, wherein
when the detection section detects the removal operation of the stacking section, the control section switches the transport destination of the medium to the second discharge section by using the switching section and also, after the discharge of the medium from the discharge section is stopped, releases the restriction of removal of the stacking section by the restriction section.

9. The medium discharge device according to claim 8, wherein
the control section stops discharge of subsequent medium from the discharge section after completion of discharge from the discharge section of the medium that reached the switching section at a time that the detection section detected the removal operation of the stacking section.

10. The medium discharge device according to claim 8, wherein
when the detection section detects the removal operation of the stacking section and the second stacking section is capable of having the medium stacked thereon, the control section switches the transport destination of the medium to the second discharge section by the switching section and also, after stopping the discharge of the medium from the discharge section, releases the restriction of removal of the stacking section by the restriction section.

11. The medium discharge device according to claim 8, wherein
when the detection section detects the removal operation of the stacking section and the second stacking section is not capable of having the medium stacked thereon, the control section stops transport of the medium by the transport section and also, after stopping the discharge of the medium from the discharge section, releases the restriction of removal of the stacking section by the restriction section.

12. The medium discharge device according to claim 8, further comprising:
the second stacking section.

13. The medium discharge device according to claim 1, further comprising:
a second stacking section on which the medium is stacked;
a second discharge section that discharges the medium to the second stacking section;
a transport section configured to transport the medium to the discharge section and the second discharge section; and
a switching section that switches a transport destination of the medium by the transport section between the discharge section and the second discharge section, wherein
when the detection section detects the removal operation of the stacking section, the control section switches the transport destination of the medium to the second discharge section by using the switching section and also, after the discharge of the medium from the discharge section is stopped, releases the restriction of removal of the stacking section by the restriction section.

14. A medium processing device comprising:
a process section that performs processing on a medium and
the medium discharge device, according to claim 1, that discharges the medium processed by the process section.

15. A control method for a medium discharge device including a mount section to which a stacking section on which a medium is stacked is detachably mounted, and a discharge section that discharges the medium to the stacking section mounted on the mounting portion, the method comprising:
stopping the discharge of the medium from the discharge section when a removal operation of the stacking section for removing the stacking section from the mount section is detected and
releasing the restriction of removal of the stacking section from the mount section after the discharge of the medium from the discharge section is stopped.
